(19) United States
(12) Patent Application Publication
(10) Pub. No.: US 2022/0260497 A1
(43) Pub. Date: Aug. 18, 2022

(54) GAS MIXTURE-BASED LIBS SIGNAL ENHANCEMENT APPARATUS AND HEAVY METAL DETECTION METHOD

(71) Applicant: ZHEJIANG UNIVERSITY, HANGZHOU (CN)

(72) Inventors: FEI LIU, HANGZHOU (CN); TINGTING SHEN, HANGZHOU (CN); WEI WANG, HANGZHOU (CN); WENWEN KONG, HANGZHOU (CN); XIAODAN LIU, HANGZHOU (CN); RONGQIN CHEN, HANGZHOU (CN)

(21) Appl. No.: 17/626,098

(22) PCT Filed: Jun. 10, 2020
(86) PCT No.: PCT/CN2020/095372

§ 371 Date: Jan. 10, 2022

(30) Foreign Application Priority Data
Mar. 17, 2020 (CN) 202010187094.3

(51) Int. Cl. G01N 21/71; G01N 1/38; H01J 49/10; H01J 49/00

(52) U.S. Cl. CPC G01N 21/718; G01N 1/38; G01N 2201/08; H01J 49/0036; G01N 2201/06113; H01J 49/105

(57) ABSTRACT

The present disclosure provides a gas mixture-based laser-induced breakdown spectroscopy (LIBS) signal enhancement apparatus and a heavy metal detection method. The apparatus includes a pulsed solid-state laser 1, an optical path system 2, a spherical gas mixing chamber 3, a fiber-optic receiver 4, a spectrometer 5, and a controller 8. The optical path system 2 is connected to the pulsed solid-state laser 1. The spherical gas mixing chamber 3 is disposed opposite to the optical path system 2. The fiber-optic receiver 4 is disposed opposite to the spherical gas mixing chamber 3. The spectrometer 5 is connected to the fiber-optic receiver 4. The controller 8 is connected to the spectrometer 5 and the pulsed solid-state laser 1. The spectrometer 5 determines LIBS information based on an optical signal received by the fiber-optic receiver 4. The controller 8 determines a LIBS spectrogram based on the LIBS information.

### CROSS REFERENCE TO RELATED APPLICATION

This is a U.S. national stage application under 35 U.S.C. 371 of PCT Application No. PCT/CN2020/095372, filed Jun. 10, 2020, which claims priority of Chinese Application No. 202010187094.3, filed Mar. 17, 2020, all of which are hereby incorporated by reference.

### TECHNICAL FIELD

The present disclosure belongs to the field of laser-induced breakdown spectroscopy (LIBS) spectrogram detection, and in particular, relates to a gas mixture-based LIBS signal enhancement apparatus and a heavy metal detection method.

### BACKGROUND ART

Human activities related to industry, agriculture, and urban pollution have caused the accumulation of heavy metals in the environment. For example, in agriculture, excessive heavy metals in an agricultural ecosystem affect physiological and biochemical processes of crops, and even inhibit crop growth and cause cell death to some extent. In addition, the heavy metals may be transmitted to animals and human bodies through food chains, resulting in severe health issues. Therefore, fast detection of heavy metal contents in agricultural ecological environment such as soil and crops helps determine a status of heavy metals in the crops and their contact environment, can provide technical means for studying absorption and accumulation rules of heavy metals in plants, and is of great significance for agricultural food safety supervision.

A traditional and commonly-used laboratory chemical testing method generally requires a high-temperature and high-acid environment for sample pretreatment, and has large human errors, high costs, and low efficiency. As an effective metal element detection technique, LIBS uses high-energy laser pulses to ablate a to-be-detected sample to instantly generate laser plasma with extremely high temperature and luminance on the surface of the sample. The plasma spectrum corresponds one-to-one with the elements of the sample, showing a specific quantitative relationship. The LIBS technique has the advantages of convenient, fast, micro-trace, and simultaneous multi-element detection, and has been applied in aerospace, environment, food, and other fields.

Comparatively, the application of LIBS in the field of agriculture is more challenging. This is mainly due to complex and varied composition of samples from soils, crops, and some agricultural products, which ultimately creates a complex matrix effect and interferes with LIBS detection performance. How to improve quantitative analysis performance of LIBS for trace elements has been a hot research field. LIBS signal enhancement technologies are the focus in this hot research field. Plasma expands from heating to cooling, generating emission spectral signals of energy level transition. The change of an atmosphere affects an evolution mechanism of laser-induced plasma over time. Some researchers have found that the status of the plasma is closely related to its ambient atmosphere. LIBS spectrograms can be enhanced by changing the atmosphere of the plasma. However, how to use a gas mixture atmosphere to enhance LIBS spectrograms has not yet been disclosed.

### SUMMARY

In view of this, the present disclosure provides a gas mixture-based LIBS signal enhancement apparatus and a heavy metal detection method to enhance LIBS spectral signal and improve accuracy of determined heavy metal contents by changing an atmosphere of plasma.

To achieve the above objective, the present disclosure provides a gas mixture-based LIBS signal enhancement apparatus, including:

a pulsed solid-state laser, configured to generate laser;

an optical path system, connected to the pulsed solid-state laser and configured to transmit the laser;

a spherical gas mixing chamber, disposed opposite to the optical path system and configured to provide a uniform gas mixture atmosphere for a to-be-detected sample;

a fiber-optic receiver, disposed opposite to the spherical gas mixing chamber and configured to receive an optical signal generated when a plasma signal diffuses, where the plasma signal is generated by using the laser to ablate the to-be-detected sample;

a spectrometer, connected to the fiber-optic receiver and configured to determine LIBS information based on the optical signal received by the fiber-optic receiver; and

a controller, connected to the spectrometer and the pulsed solid-state laser; and configured to process a LIBS spectrogram based on the LIBS information, and obtain instrument parameters and generate a control instruction based on the instrument parameters to control the pulsed solid-state laser to generate the laser, where the instrument parameters include laser energy and a distance between a lens in the optical path system and a surface of the to-be-detected sample.

Optionally, the apparatus may further include:

a time delay integration (TDI) generator, connected to the controller and the spectrometer, and configured to control a working timing of the spectrometer based on a delay time and an integration time in the instrument parameters.

Optionally, the spherical gas mixing chamber may include:

a first gas storage tank, configured to store argon;

a second gas storage tank, configured to store helium;

a third gas storage tank, configured to store nitrogen;

a gas mixing tank, connected to the first gas storage tank, the second gas storage tank, and the third gas storage tank by using pipes and configured to mix the argon, helium, and nitrogen to obtain a gas mixture;

a gas distributor, connected to the gas mixing tank by using a pipe and configured to distribute the gas mixture in the gas mixing tank;

a gas cabin with a sample stage, configured to place the to-be-detected sample on the sample stage and opposite to the optical path system;

a plurality of gas transmission pipes, connected to the gas distributor and the gas cabin, and configured to transmit the gas mixture in the gas mixing tank to the gas cabin, to provide the uniform gas mixture atmosphere for the to-be-detected sample; and

a vacuum pump, connected to the gas mixing tank by using a pipe and configured to vacuumize the gas mixing tank.

Optionally, the spherical gas mixing chamber may further include:

a quartz diaphragm, disposed at the top of the gas cabin, having a same normal as the fiber-optic receiver, and configured to pass through the plasma signal generated by using the laser to ablate the to-be-detected sample, so that the fiber-optic receiver receives the optical signal generated when the plasma signal diffuses.

Optionally, the spherical gas mixing chamber may further include:

a control valve, disposed on the pipe between the gas distributor and the gas mixing tank, connected to the controller, and configured to control, based on the control instruction generated by the controller, a flow velocity of the gas mixture flowing out of the gas mixing tank.

Optionally, the spherical gas mixing chamber may further include:

an exhaust valve, disposed at the bottom of the gas cabin and configured to: when gas pressure in the gas cabin is higher than atmospheric pressure, automatically discharge part of the gas mixture to maintain stability of the gas pressure in the gas cabin.

Optionally, the gas cabin may be a sphere with a diameter of 20 cm. The quartz diaphragm is disposed at the top of the sphere. The quartz diaphragm may be a circle with a diameter of 3 cm. A plurality of gas inlets connected to the gas transmission pipes may be uniformly disposed on the upper half of the sphere. The plurality of gas inlets are on a same plane. The plane is parallel to the sample stage and the quartz diaphragm. A number of the gas inlets is the same as that of the gas transmission pipes. The plurality of gas transmission pipes are inserted into the gas cabin through the gas inlets.

The present disclosure further provides a heavy metal detection method, including:

determining a to-be-detected sample;

detecting the to-be-detected sample by using the foregoing gas mixture-based LIBS signal enhancement apparatus to obtain LIBS information;

performing standard normal variate transformation (SNVT) on the LIBS information to process a LIBS spectrogram;

establishing an emission line intensity-heavy metal content multiple linear regression (MLR) model; and

inputting the LIBS spectrogram into the MLR model to determine a heavy metal content.

Optionally, the establishing an emission line intensity-heavy metal content MLR model may specifically include:

obtaining a plurality of samples in test set;

measuring heavy metal contents of samples in the test set by using inductively coupled plasma mass spectrometry (ICP-MS);

detecting samples in the test set by using the gas mixture-based LIBS signal enhancement apparatus to obtain LIBS information corresponding to the samples in test set.

performing SNVT on the LIBS information corresponding to the samples in test set to determine LIBS spectrograms corresponding to the samples in test set;

using a genetic algorithm to obtain characteristic wave bands related to heavy metals from the LIBS spectrograms corresponding to the samples in test set;

selecting a plurality of emission lines of heavy metals from the characteristic wave bands based on a National Institute of Standards and Technology (NIST) database; and

establishing the emission line intensity-heavy metal content MLR model by using an MLR method with the plurality of emission lines of heavy metals as an input and the heavy metal contents in the samples in test set as an output.

Optionally, the determining a to-be-detected sample may specifically include:

selecting to-be-detected plants of same growth;

performing various gradients of CuCl₂ solution stress treatments on the to-be-detected plants; and

collecting the to-be-detected plants after specified days and performing washing, drying, grinding, sifting, and tableting to obtain the to-be-detected sample.

Based on specific embodiments provided in the present disclosure, the present disclosure has the following technical effects:

The present disclosure provides a gas mixture-based LIBS signal enhancement apparatus and a heavy metal detection method. The apparatus includes a pulsed solid-state laser, an optical path system, a spherical gas mixing chamber, a fiber-optic receiver, a spectrometer, and a controller. The optical path system is connected to the pulsed solid-state laser. The spherical gas mixing chamber is disposed opposite to the optical path system. The fiber-optic receiver is disposed opposite to the spherical gas mixing chamber. The spectrometer is connected to the fiber-optic receiver. The controller is connected to the spectrometer and the pulsed solid-state laser. The spectrometer determines LIBS information based on an optical signal received by the fiber-optic receiver. The controller determines a LIBS spectrogram based on the LIBS information. The apparatus can provide a uniform gas mixture atmosphere for plasma generated by using laser to ablate a to-be-detected sample, and adjust a ratio of input gases to air based on detection requirements to adjust gas pressure, to enhance the LIBS spectrogram and improve accuracy of a determined heavy metal content.

### BRIEF DESCRIPTION OF THE DRAWINGS

In order to explain the technical solutions in embodiments of the present disclosure or in the prior art more clearly, the accompanying drawings required in the embodiments will be described below briefly. Apparently, the accompanying drawings in the following description show merely some embodiments of the present disclosure, and other drawings can be derived from these accompanying drawings by those of ordinary skill in the art without creative efforts.

FIG. 1 is a schematic structural diagram of a signal enhancement apparatus according to an embodiment of the present disclosure;

FIG. 2 is a top view of a spherical gas cabin in a signal enhancement apparatus according to an embodiment of the present disclosure;

FIG. 3 is a side view of a spherical gas cabin in a signal enhancement apparatus according to an embodiment of the present disclosure;

FIG. 4 is a schematic structural diagram of a signal enhancement apparatus being used according to an embodiment of the present disclosure; and

FIG. 5 is a flowchart of a heavy metal detection method according to an embodiment of the present disclosure.

1. pulsed solid-state laser; 2. optical path system; 3. spherical gas mixing chamber; 4. fiber-optic receiver; 5. spectrometer; 6. TDI generator; 7. wire; 8. controller; 3-1. first gas storage tank; 3-2. second gas storage tank; 3-3. third gas storage tank; 3-4. control valve; 3-5. vacuum pump; 3-6. gas distributor; 3-7. gas transmission pipe; 3-8. gas inlet; 3-9. sample stage; 3-10. exhaust valve; 3-11. gas cabin; 3-12. gas mixing tank; 3-13. quartz diaphragm.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure provides a gas mixture-based LIBS signal enhancement apparatus and a heavy metal detection method to enhance LIBS spectrograms and improve accuracy of determined heavy metal contents by changing an atmosphere of plasma.

To make the foregoing objective, features, and advantages of the present disclosure clearer and more comprehensible, the present disclosure will be further described in detail below with reference to the accompanying drawings and specific embodiments.

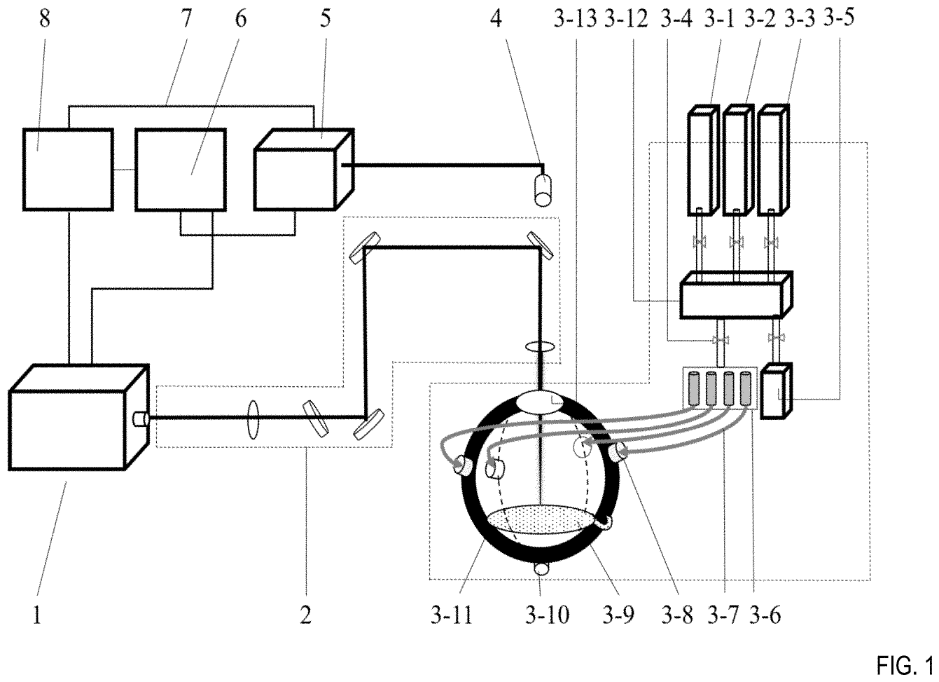

FIG. 1 is a schematic structural diagram of a signal enhancement apparatus according to an embodiment of the present disclosure. As shown in FIG. 1, the present disclosure provides a gas mixture-based LIBS signal enhancement apparatus, including a pulsed solid-state laser 1, an optical path system 2, a spherical gas mixing chamber 3, a fiber-optic receiver 4, a spectrometer 5, and a controller 8. The optical path system 2 is connected to the pulsed solid-state laser 1. The spherical gas mixing chamber 3 is disposed opposite to the optical path system 2. The fiber-optic receiver 4 is disposed opposite to the spherical gas mixing chamber 3. The spectrometer 5 is connected to the fiber-optic receiver 4 by using wire 7. The controller 8 is connected to the spectrometer 5 and the pulsed solid-state laser 1 respectively by using the wire 7.

The pulsed solid-state laser 1 is configured to generate laser. The optical path system 2 is configured to transmit the laser. The spherical gas mixing chamber 3 is configured to provide a uniform gas mixture atmosphere for a to-be-detected sample. The fiber-optic receiver 4 is configured to receive an optical signal generated when a plasma signal diffuses. The plasma signal is generated by using the laser to ablate the to-be-detected sample. The spectrometer 5 is configured to determine LIBS information based on the optical signal received by the fiber-optic receiver 4. The controller 8 is configured to process a LIBS spectrogram based on the LIBS information, and obtain instrument parameters and generate a control instruction based on the instrument parameters to control the pulsed solid-state laser 1 to generate the laser. The instrument parameters include laser energy and a distance between a lens in the optical path system 2 and a surface of the to-be-detected sample.

In an embodiment, the apparatus in the present disclosure may further include:

a TDI generator 6, connected to the controller 8 and the spectrometer 5 by using the wire 7 and configured to control a working timing of the spectrometer 5 based on a delay time and an integration time in the instrument parameters.

In an embodiment, the spherical gas mixing chamber 3 in the present disclosure may include a first gas storage tank 3-1, a second gas storage tank 3-2, a third gas storage tank 3-3, a gas mixing tank 3-12, a gas distributor 3-6, a gas cabin 3-11 with a sample stage 3-9, a plurality of gas transmission pipes 3-7, and a vacuum pump 3-5. The gas mixing tank 3-12 is connected to the first gas storage tank 3-1, the second gas storage tank 3-2, and the third gas storage tank 3-3 by using pipes. The gas distributor 3-6 is connected to the gas mixing tank 3-12 by using a pipe. The plurality of gas transmission pipes 3-7 are connected to the gas distributor 3-6 and the gas cabin 3-11. The vacuum pump 3-5 is connected to the gas mixing tank 3-12 by using a pipe.

The first gas storage tank 3-1 is configured to store argon. The second gas storage tank 3-2 is configured to store helium. The third gas storage tank 3-3 is configured to store nitrogen. The gas mixing tank 3-12 is configured to mix the argon, helium, and nitrogen to obtain a gas mixture. The gas distributor 3-6 is configured to distribute the gas mixture in the gas mixing tank 3-12. The gas cabin 3-11 with the sample stage 3-9 is configured to place the to-be-detected sample on the sample stage 3-9 and opposite to the optical path system 2. The plurality of gas transmission pipes 3-7 are configured to transmit the gas mixture in the gas mixing tank to the gas cabin 3-11, to provide the uniform gas mixture atmosphere for the to-be-detected sample. The vacuum pump 3-5 is configured to vacuumize the gas mixing tank 3-12. The fiber-optic receiver 4 is perpendicular to a surface of the sample stage 3-9.

In an embodiment, the spherical gas mixing chamber 3 in the present disclosure may further include:

a quartz diaphragm 3-13, disposed at the top of the gas cabin 3-11, having a same normal as the fiber-optic receiver 4, and configured to pass through the plasma signal generated by using the laser to ablate the to-be-detected sample, so that the fiber-optic receiver 4 receives the optical signal generated when the plasma signal diffuses.

In an embodiment, the spherical gas mixing chamber 3 in the present disclosure may further include:

a control valve 3-4, disposed on the pipe between the gas distributor 3-6 and the gas mixing tank 3-12, connected to the controller 8, and configured to control, based on the control instruction generated by the controller 8, a flow velocity of the gas mixture flowing out of the gas mixing tank 3-12.

In an embodiment, the spherical gas mixing chamber 3 in the present disclosure may further include:

an exhaust valve 3-10, disposed at the bottom of the gas cabin 3-11. When gas pressure in the gas cabin 3-11 is higher than atmospheric pressure, the exhaust valve 3-10 automatically discharges part of the gas mixture to maintain stability of the gas pressure in the gas cabin 3-11.

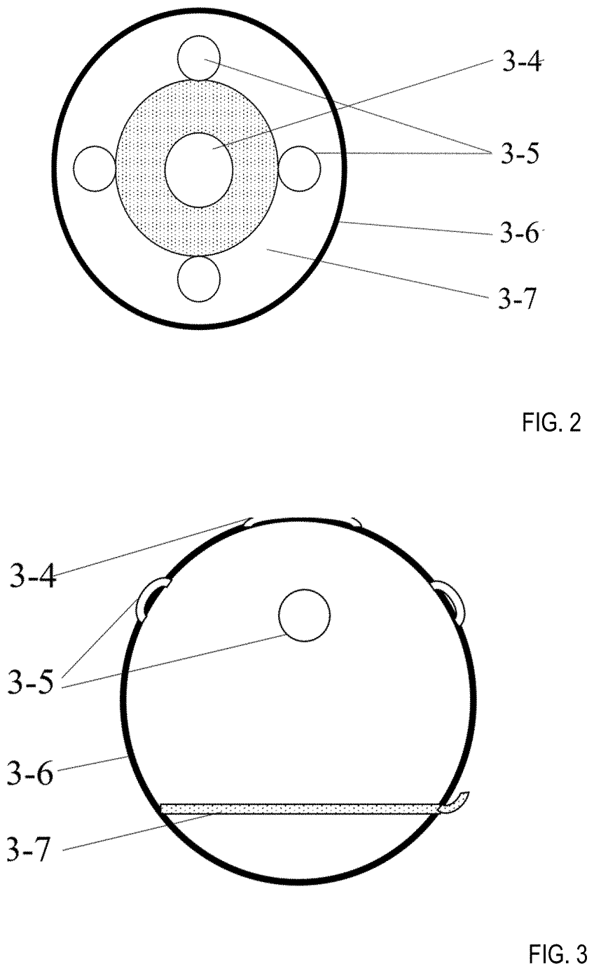

FIG. 2 is a top view of a spherical gas cabin in a signal enhancement apparatus according to an embodiment of the present disclosure. FIG. 3 is a side view of a spherical gas cabin in a signal enhancement apparatus according to an embodiment of the present disclosure. As shown in FIG. 2 and FIG. 3, the gas cabin 3-11 in the present disclosure is a sphere with a diameter of 20 cm. The quartz diaphragm 3-13 with a transmittance of more than 99% is disposed at the top of the sphere. The quartz diaphragm 3-13 is a circle with a diameter of 3 cm. A plurality of gas inlets 3-8 connected to the gas transmission pipes 3-7 are uniformly disposed on the upper half of the sphere. The plurality of gas inlets 3-8 are on a same plane. The plane is parallel to the sample stage 3-9 and the quartz diaphragm 3-13. A number of the gas inlets 3-8 is the same as that of the gas transmission pipes 3-7. The plurality of gas transmission pipes 3-7 are inserted into the gas cabin 3-11 through the gas inlets 3-8. The removable sample stage 3-9 is disposed in the lower part at a distance of 5 cm from a bottom center of the sphere. A ring pulls on a side of the sample stage 3-9 facilitates pulling out the sample stage 3-9. When the gas pressure in the gas cabin 3-11 is higher than the atmospheric pressure, the exhaust valve 3-10 automatically discharges the part of the gas mixture.

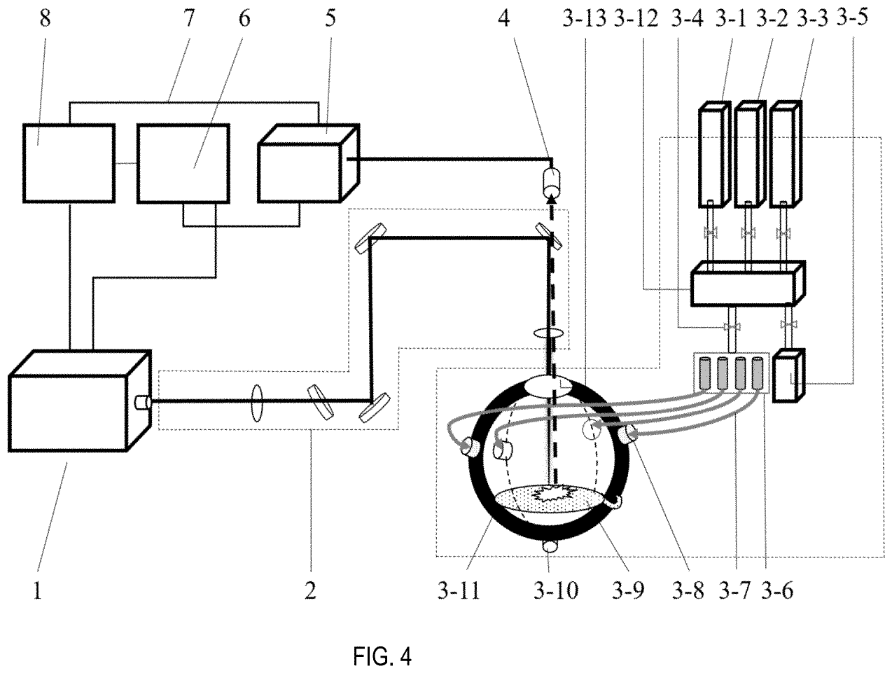

FIG. 4 is a schematic structural diagram of a signal enhancement apparatus being used according to an embodiment of the present disclosure.

Set the instrument parameters: Turn on the pulsed solid-state laser 1, the spectrometer 5, the TDI generator 6, and the controller 8 in sequence and wait for the apparatus to be stable. The instrument parameters include the delay time of 2 μs, the integration time of 18 μs, the distance of 98 mm between the lens and the surface of the sample, and the laser energy of 80 mJ.

Obtain a uniform argon, helium, and nitrogen mixture atmosphere: First, turn on the vacuum pump 3-5 to vacuumize the gas mixing tank 3-12. Then, open valves of the first gas storage tank 3-1, the second gas storage tank 3-2, and the third gas storage tank 3-3 and set a flow velocity to 2 L/min to simultaneously input argon, helium, and nitrogen into the gas mixing tank 3-12. After the gases are mixed, open the control valve 3-4 and set a flow velocity to 6 L/min to uniformly distribute the gas mixture to four pipes of gases by using the gas distributor 3-6 and input the gases to the gas cabin 3-11 through the gas transmission pipes 3-7. After the exhaust valve 3-10 at the bottom of the gas cabin 3-11 is automatically opened, the uniform argon, helium, and nitrogen mixture atmosphere for experiments is obtained.

Obtain the LIBS spectrogram of the sample: Remove the sample stage 3-9 from the bottom of the gas cabin 3-11, place the to-be-detected sample on the sample stage 3-9, and then insert the sample stage 3-9 into the gas cabin 3-11. The pulsed solid-state laser 1 is turned on by the controller 8 to generate the laser with a wavelength of 532 nm. The laser is transmitted to the surface of the to-be-detected sample in the gas cabin 3-11 through the optical path system 2. The laser ablates the to-be-detected sample to generate the plasma signal. The fiber-optic receiver 4 receives the optical signal generated when the plasma signal diffuses. The fiber-optic receiver 4 transmits the optical signal to the spectrometer 5. The spectrometer 5 processes the optical signal to obtain the LIBS information and transmits the LIBS information to spectral information collection software of the controller 8. Then, the LIBS spectrogram is obtained.

To obtain the LIBS spectrogram of the to-be-detected sample, a focus of the fiber-optic receiver 4 is required to coincide with a focus generated by the laser through the lens in the optical path system 2, and pass through the quartz diaphragm 3-13 disposed at the top of the gas cabin 3-11 to prevent signals being blocked by a stainless-steel body on a side wall.

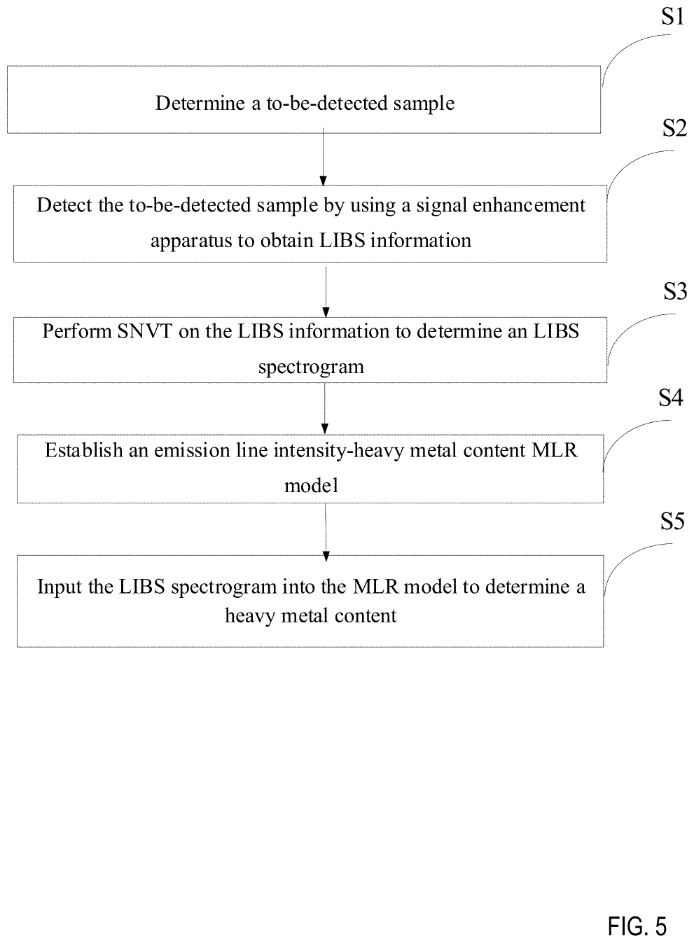

FIG. 5 is a flowchart of a heavy metal detection method according to an embodiment of the present disclosure. As shown in FIG. 5, the present disclosure further provides a heavy metal detection method, including the following steps:

Step S1: Determine a to-be-detected sample.

Step S2: After instrument parameters of the foregoing gas mixture-based LIBS signal enhancement apparatus are set, detect the to-be-detected sample by using the gas mixture-based LIBS signal enhancement apparatus to obtain LIBS information. The instrument parameters that are set include a delay time of 2 μs, an integration time of 18 μs, a distance of 98 mm between a lens and a surface of the sample, and laser energy of 80 mJ.

Step S3: Perform SNVT on the LIBS information to obtain a LIBS spectrogram.

Step S4: Establish an emission line intensity-heavy metal content MLR model.

Step S5: Input the LIBS spectrogram into the MLR model to determine a heavy metal content.

In an embodiment, step S1 of determining the to-be-detected sample may specifically include the following steps:

Step S11: Select to-be-detected plants of same growth.

Step S12: Perform various gradients of CuCl₂ solution stress treatments on the to-be-detected plants. CuCl₂ solution used to perform the stress treatments on the to-be-detected plants includes five gradients: 0 μM, 5 μM, 30 μM, 70 μM, and 100 μM.

Step S13: Collect the to-be-detected plants after specified days and perform washing, drying, grinding, sifting, and tableting to obtain the to-be-detected sample. The sample has mass of 0.20 g, a length of 10 mm, a width of 10 mm, and a height of 2 mm.

In an embodiment, step S4 of establishing the emission line intensity-heavy metal content MLR model may specifically include the following steps:

Step S41: Obtain a plurality of samples in test set.

Step S42: Measure heavy metal contents in the samples in test set by using ICP-MS.

Step S43: Detect the samples in test set by using the gas mixture-based LIBS signal enhancement apparatus to obtain LIBS information corresponding to the samples in test set.

Step S44: Perform SNVT on the LIBS information corresponding to the samples in test set to determine LIBS spectrograms corresponding to the samples in test set.

Step S45: Use a genetic algorithm to obtain characteristic wave bands related to heavy metals from the LIBS spectrograms corresponding to the samples in test set.

Step S46: Select a plurality of emission lines of heavy metals from the characteristic wave bands based on a NIST database.

Step S47: Establish the emission line intensity-heavy metal content MLR model by using an MLR method with the plurality of emission lines of heavy metals as an input and the heavy metal contents in the samples in test set as an output.

A specific method for detecting a copper content in rice leaves by using the apparatus in the present disclosure includes the following steps:

Step S1: Cultivate rice plants, select plants of same growth, and perform various gradients of CuCl₂ solution stress treatments on the plants. Collect the plants after 20 days and perform washing, fast drying, grinding, sifting, and tableting to obtain a to-be-detected sample. CuCl₂ solution used to perform the stress treatments on the plants includes five gradients: 0 μM, 5 μM, 30 μM, 70 μM, and 100 μM. 20 mM Na₂EDTA and distilled water are successively used to wash the plants. Then, the plants are dried in an oven at 80° C. An automatic grinding machine is used to grind the plants with a frequency of 60 Hz and a time period of 80 s. The obtained sample has mass of 0.20 g, a length of 10 mm, a width of 10 mm, and a height of 2 mm.

Step S2: Set instrument parameters of a gas mixture-based LIBS signal enhancement apparatus and use the signal enhancement apparatus to obtain LIBS information X of the to-be-detected sample in step S1. The instrument parameters include a delay time of 2 μs, an integration time of 18 μs, a distance of 98 mm between a lens and a surface of the sample, and laser energy of 80 mJ.

Step S3: Perform SNVT on the LIBS information X to obtain a LIBS spectrogram X1.

Step S4: Establish a copper emission line intensity-copper content MLR model.

Step S5: Input the LIBS spectrogram into the copper emission line intensity-copper content MLR model to determine a copper content.

Step S4 of establishing the copper emission line intensity-copper content MLR model may specifically include the following steps:

Step S41: Measure a copper content y in each sample in test set by using ICP-MS.

Step S42: Use a genetic algorithm to obtain characteristic wave bands x related to copper in rice leaves from a LIBS spectrogram X1 corresponding to each sample in test set.

Step S43: Find two copper emission lines from the characteristic wave bands x based on a NIST database, and record the emission lines as Cu I 324.87 nm and Cu I 327.46 nm.

Step S44: Establish the following copper emission line intensity-copper content MLR model by using an MLR method with the copper emission line intensities of 1324 and 1327 as input vectors and the copper content y as an output vector: yd=0.7506I₃₂₇−0.3489I₃₂₄−198.5752. A correlation reaches 0.96.

Compared with the prior art, the present disclosure has the following advantages:

(1) The apparatus in the present disclosure includes the spherical gas mixing chamber, which can provide a uniform gas mixture atmosphere for plasma generated by using laser to ablate samples. A ratio of multiple gases can be adjusted based on detection requirements. The atmosphere of the plasma is changed to enhance LIBS spectrograms and improve accuracy of determined heavy metal contents.

(2) The gas mixture-based LIBS signal enhancement apparatus in the present disclosure features no contact with strong acid and alkali reagents, simple and fast operations, and low costs.

(3) The present disclosure can control a mixing ratio of multiple gases and implement mixing of different ratios of gases.

(4) The present disclosure enhances LIBS spectrograms by using a gas mixture atmosphere, to improve accuracy and sensitivity of quantitative detection of heavy metal contents.

(5) The gas mixture-based LIBS signal enhancement apparatus is used to implement fast, accurate, and large-scale detection of heavy metals.

Each embodiment of this specification is described in a progressive manner, each embodiment focuses on the difference from other embodiments, and the same and similar parts between the embodiments may refer to each other.

In this specification, several specific embodiments are used for illustration of the principles and implementations of the present disclosure. The description of the foregoing embodiments is used to help illustrate the method of the present disclosure and the core ideas thereof. In addition, persons of ordinary skill in the art can make various modifications in terms of specific implementations and the scope of application in accordance with the ideas of the present disclosure. In conclusion, the content of this specification shall not be construed as a limitation to the present disclosure.

What is claimed is:

1. A gas mixture-based laser-induced breakdown spectroscopy (LIBS) signal enhancement apparatus, comprising:
a pulsed solid-state laser, configured to generate laser;
an optical path system, connected to the pulsed solid-state laser and configured to transmit the laser;
a spherical gas mixing chamber, disposed opposite to the optical path system and configured to provide a uniform gas mixture atmosphere for a to-be-detected sample;
a fiber-optic receiver, disposed opposite to the spherical gas mixing chamber and configured to receive an optical signal generated when a plasma signal diffuses, wherein the plasma signal is generated by using the laser to ablate the to-be-detected sample;
a spectrometer, connected to the fiber-optic receiver and configured to determine LIBS information based on the optical signal received by the fiber-optic receiver; and
a controller, connected to the spectrometer and the pulsed solid-state laser; and configured to process a LIBS spectrogram based on the LIBS information, and obtain instrument parameters and generate a control instruction based on the instrument parameters to control the pulsed solid-state laser to generate the laser, wherein the instrument parameters comprise laser energy and a distance between a lens in the optical path system and a surface of the to-be-detected sample.

2. The gas mixture-based LIBS signal enhancement apparatus according to claim 1, further comprising:
a time delay integration (TDI) generator, connected to the controller and the spectrometer, and configured to control a working timing of the spectrometer based on a delay time and an integration time in the instrument parameters.

3. The gas mixture-based LIBS signal enhancement apparatus according to claim 1, wherein the spherical gas mixing chamber comprises:
a first gas storage tank, configured to store argon;
a second gas storage tank, configured to store helium;
a third gas storage tank, configured to store nitrogen;
a gas mixing tank, connected to the first gas storage tank, the second gas storage tank, and the third gas storage tank by using pipes and configured to mix the argon, helium, and nitrogen to obtain a gas mixture;
a gas distributor, connected to the gas mixing tank by using a pipe and configured to distribute the gas mixture in the gas mixing tank;
a gas cabin with a sample stage, configured to place the to-be-detected sample on the sample stage and opposite to the optical path system;
a plurality of gas transmission pipes, connected to the gas distributor and the gas cabin, and configured to transmit the gas mixture in the gas mixing tank to the gas cabin, to provide the uniform gas mixture atmosphere for the to-be-detected sample; and
a vacuum pump, connected to the gas mixing tank by using a pipe and configured to vacuumize the gas mixing tank.

4. The gas mixture-based LIBS signal enhancement apparatus according to claim 3, wherein the spherical gas mixing chamber further comprises:
a quartz diaphragm, disposed at the top of the gas cabin, having a same normal as the fiber-optic receiver, and configured to pass through the plasma signal generated by using the laser to ablate the to-be-detected sample, so that the fiber-optic receiver receives the optical signal generated when the plasma signal diffuses.

5. The gas mixture-based LIBS signal enhancement apparatus according to claim 3, wherein the spherical gas mixing chamber further comprises:
a control valve, disposed on the pipe between the gas distributor and the gas mixing tank, connected to the controller, and configured to control, based on the control instruction generated by the controller, a flow velocity of the gas mixture flowing out of the gas mixing tank.

6. The gas mixture-based LIBS signal enhancement apparatus according to claim 3, wherein the spherical gas mixing chamber further comprises:
an exhaust valve, disposed at the bottom of the gas cabin and configured to: when gas pressure in the gas cabin is higher than atmospheric pressure, automatically discharge part of the gas mixture to maintain stability of the gas pressure in the gas cabin.

7. The gas mixture-based LIBS signal enhancement apparatus according to claim 3, wherein the gas cabin is a sphere with a diameter of 20 cm, and the quartz diaphragm is disposed at the top of the sphere; the quartz diaphragm is a circle with a diameter of 3 cm, a plurality of gas inlets connected to the gas transmission pipes are uniformly disposed on the upper half of the sphere, the plurality of gas inlets are on a same plane, and the plane is parallel to the sample stage and the quartz diaphragm; and a number of the gas inlets is the same as that of the gas transmission pipes, and the plurality of gas transmission pipes are inserted into the gas cabin through the gas inlets.

8. A heavy metal detection method, comprising:
determining a to-be-detected sample;
detecting the to-be-detected sample by using the gas mixture-based LIBS signal enhancement apparatus according to claim 1 to obtain LIBS spectral information;
performing standard normal variate transformation (SNVT) on the LIBS information to process a LIBS spectrogram;
establishing an emission line intensity-heavy metal content multiple linear regression (MLR) model; and
inputting the LIBS spectrogram into the MLR model to determine a heavy metal content.

9. The heavy metal detection method according to claim 8, further comprising:
a time delay integration (TDI) generator, connected to the controller and the spectrometer, and configured to control a working timing of the spectrometer based on a delay time and an integration time in the instrument parameters.

10. The heavy metal detection method according to claim 8, wherein the spherical gas mixing chamber comprises:
a first gas storage tank, configured to store argon;
a second gas storage tank, configured to store helium;
a third gas storage tank, configured to store nitrogen;
a gas mixing tank, connected to the first gas storage tank, the second gas storage tank, and the third gas storage tank by using pipes and configured to mix the argon, helium, and nitrogen to obtain a gas mixture;
a gas distributor, connected to the gas mixing tank by using a pipe and configured to distribute the gas mixture in the gas mixing tank;
a gas cabin with a sample stage, configured to place the to-be-detected sample on the sample stage and opposite to the optical path system;
a plurality of gas transmission pipes, connected to the gas distributor and the gas cabin, and configured to transmit the gas mixture in the gas mixing tank to the gas cabin, to provide the uniform gas mixture atmosphere for the to-be-detected sample; and
a vacuum pump, connected to the gas mixing tank by using a pipe and configured to vacuumize the gas mixing tank.

11. The heavy metal detection method according to claim 10, wherein the spherical gas mixing chamber further comprises:
a quartz diaphragm, disposed at the top of the gas cabin, having a same normal as the fiber-optic receiver, and configured to pass through the plasma signal generated by using the laser to ablate the to-be-detected sample, so that the fiber-optic receiver receives the optical signal generated when the plasma signal diffuses.

12. The heavy metal detection method according to claim 10, wherein the spherical gas mixing chamber further comprises:
a control valve, disposed on the pipe between the gas distributor and the gas mixing tank, connected to the controller, and configured to control, based on the control instruction generated by the controller, a flow velocity of the gas mixture flowing out of the gas mixing tank.

13. The heavy metal detection method according to claim 10, wherein the spherical gas mixing chamber further comprises:
an exhaust valve, disposed at the bottom of the gas cabin and configured to: when gas pressure in the gas cabin is higher than atmospheric pressure, automatically discharge part of the gas mixture to maintain stability of the gas pressure in the gas cabin.

14. The heavy metal detection method according to claim 10, wherein the gas cabin is a sphere with a diameter of 20 cm, and the quartz diaphragm is disposed at the top of the sphere; the quartz diaphragm is a circle with a diameter of 3 cm, a plurality of gas inlets connected to the gas transmission pipes are uniformly disposed on the upper half of the sphere, the plurality of gas inlets are on a same plane, and the plane is parallel to the sample stage and the quartz diaphragm; and a number of the gas inlets is the same as that of the gas transmission pipes, and the plurality of gas transmission pipes are inserted into the gas cabin through the gas inlets.

15. The heavy metal detection method according to claim 8, wherein the establishing an emission line intensity-heavy metal content MLR model specifically comprises:
obtaining a plurality of samples in test set;
measuring heavy metal contents in the samples in test set by using inductively coupled plasma mass spectrometry (ICP-MS);
detecting the samples in test set by using the gas mixture-based LIBS signal enhancement apparatus according to claim 1 to obtain LIBS information corresponding to the samples in test set;
performing SNVT on the LIBS information corresponding to the samples in test set to determine LIBS spectrograms corresponding to the samples in test set;
using a genetic algorithm to obtain characteristic wave bands related to heavy metals from the LIBS spectrograms corresponding to the samples in test set;
selecting a plurality of emission lines of heavy metals from the characteristic wave bands based on the National Institute of Standards and Technology (NIST) database; and
establishing the emission line intensity-heavy metal content MLR model by using an MLR method with the plurality of emission lines of heavy metals as an input and the heavy metal contents in the samples in test set as an output.

16. The heavy metal detection method according to claim 8, wherein the determining a to-be-detected sample specifically comprises:
selecting to-be-detected plants of same growth;
performing various gradients of CuCl₂ solution stress treatments on the to-be-detected plants; and
collecting the to-be-detected plants after specified days and performing washing, drying, grinding, sifting, and tableting to obtain the to-be-detected samples.
